(19) United States
(12) Patent Application Publication
(10) Pub. No.: US 2008/0209032 A1
(43) Pub. Date: Aug. 28, 2008

(54) Alarm method for insufficient storage space of network storage system

(75) Inventors: Jian-Feng Guo, Tianjin (CN); Lei Li, Tianjin (CN); Tom Chen, Taipei (TW); Win-Harn Liu, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/709,259

(22) Filed: Feb. 22, 2007

(51) Int. Cl. G06F 15/173

(52) U.S. Cl. 709/224

(57) ABSTRACT

An alarm method for insufficient storage space of a network storage system is provided. The method includes the following steps. Preset a time alarm threshold value according to a current operation state of the system when allocating storage spaces to users. Estimate a time that written data fully occupy a current remaining space according to a data writing speed to the storage space, a current idle memory of the system, total dirty data in a cache of the system, and the current remaining space in the storage space. Compare the estimated time value and the time alarm threshold value. And, send alarm information when the estimated time value is smaller than the time alarm threshold value. By setting the alarm threshold value of a time concept, a timely alarm of insufficient storage space is realized, which enhances the effective management of the storage space.

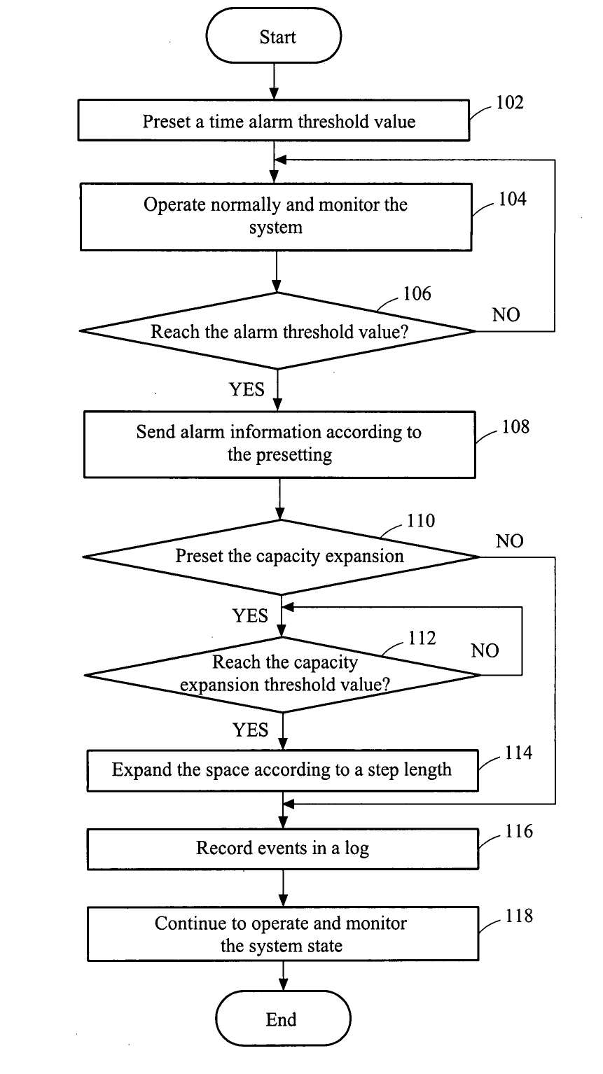

### BACKGROUND OF THE INVENTION

1. Field of Invention

The present invention relates to an alarm method for insufficient storage space of a network storage system.

2. Related Art

Currently, two prevalent network storage systems are the Storage Area Network (SAN) and the Network Attached Storage (NAS). The SAN is a network specially designed to provide data storage and backup management for business data of enterprises or data of operators, and the NAS connects storage devices to a group of computers through a standard network topological structure, which focuses on meeting the rapidly increasing requirements of workgroups and departments on storage capacity.

The management modes of user authorities and storage space quotas of the two network storage systems are described as follows. The system provides the storage space quota management of users on the basis of file system quota strategy for the convenience of the control and management of different users, so as to limit the network storage space of a specific user. As for the SAN, the space quota management of the SAN normally adopts the mode that an administrator assigns specific devices to different users for independent utilization due to the distinctive features of block devices.

It is known from the above description that the SAN and NAS use similar management modes on user authorities and spaces, i.e., the administrator sets the user authorities and spaces when they are created, and a special personnel performs modifications to the settings when variations are required in use. This mode ensures high concentration of the authorities, and is helpful to maintain the system safety. However, when unexpected situations occur, the network storage systems have defects of long response periods and passive response mechanisms. In particular, the storage space alarm threshold value is normally defined as a space concept in the conventional art, i.e., the system alarms only when the proportion of the current available space in the total space is smaller than a certain value, or when the remaining capacity of the available space in a system is a certain value. For example, in case that a user is to write data greater than the actual available space, the system alarms according to the presetting only when the remaining available space reaches the preset alarm threshold value, and at this time, the writing will not stop. Therefore, it is possible that all of the space has been occupied in fact before the administrator responses, and the writing is forced to stop by the system, which often leads to the loss of data of the user and other unnecessary troubles.

### SUMMARY OF THE INVENTION

In order to solve the problems and defects of the conventional art, the present invention provides an insufficient storage space alarm system for a network storage system and a method therefor, which realize the timely and effectively alarm of the insufficient storage space.

Accordingly, the present invention provides a method of insufficient storage space alarm for a network storage system, which includes the following steps. Preset a time alarm threshold value according to a current operation state of the system when allocating storage spaces of users. Estimate a time that written data fully occupy a current remaining space according to a data writing speed to the storage space, a current idle memory of the system, total dirty data in a cache of the system, and the current remaining space in the storage space. Compare the estimated time value and the time alarm threshold value. And, send alarm information when the estimated time value is smaller than the time alarm threshold value.

In addition, the present invention further include a step of automatic capacity expansion of the storage space, which expands the storage space according to a step length when the available space in the system reaches the set threshold value.

The present invention dynamically sets the alarm threshold value through real-time monitoring of the operation of the system, so as to effectively alarm in time. Thus, the administrator has enough time to deal with the problem of insufficient space, so as to prevent the loss of written data and to ensure the stable operation of the system. Moreover, through the addition of the automatic capacity expansion mechanism, the system can automatically expand the storage space of a user before the timely alarm response is received, so as to ensure the continuous access to the storage space, and enhance the effective management of the storage space.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The sole FIGURE is a flow chart of the steps of the method of insufficient storage space alarm for a network storage system of the present invention.

### DETAILED DESCRIPTION OF THE INVENTION

Features and examples of the preferred embodiment of the present invention are illustrated below with reference to the drawings.

The FIGURE is a flow chart of the steps of the method of insufficient storage space alarm for a network storage system of the present invention.

As shown in the FIGURE, when a storage space of a user is allocated, an alarm threshold value is preset first (step 102). The alarm threshold value is defined as a threshold value of a time concept, i.e., the alarm threshold is set on the basis of a time concept that how long the available space in a system will be used out according to the current operation state. Here, the alarm threshold value can be preset by a system administrator according to experience or a recommended value.

After the time alarm threshold value is set, the system runs normally and is monitored in real time (step 104), so as to obtain the time that the current available space will be used out according to the current operation state of the system. As the cache mechanism is widely applied in the software and hardware architecture currently, the transient performance of a certain input/output operation does not represent the normal situation of the speed of system operation. Therefore, the following information must be referred to when estimate the time that the current available space will be used out: data amount of writing requests received by the system in a recent period of time, i.e., a data writing speed obtained according to the amount of the written data in a certain period of time each time the data is written into the storage space, here, the selection of the time period is adjusted according to the hardware speed and software condition of the system, and is normally in a unit of minute; current idle memory of the system; total amount of dirty data in the cache of the system; and the available storage space of the user and so on.

Here, the dirty data refers to the data information that has not be refreshed (written) into a storage device and is temporarily stored in the cache in the system. This type of data is referred to as the “dirty data” not because of its correctness or modifications for multiple times, but because of the temporary unconformity between information in the disk and in the memory as being delayed by the cache strategy of the system. Therefore, according to the above information, the time required to write data to all of the current available space in the storage space is estimated comprehensively, and thus, the time that the current available space will be used out can be obtained.

When the data is written into the storage space, if it is determined that the current remaining space has some influence on the system performance, a file system layer (e.g., the NAS) or a block device layer (e.g., the SAN) will be operated according to the determination. As the determination operation is performed between a CPU and the memory, and the subsequent writing is performed in a slower physical device layer, the determination operation of a nanosecond scale will be flushed by the input/output operation of a millisecond scale, and causes little influence on the system performance.

Meanwhile, the system compares the obtained estimated time with the time alarm threshold value, so as to determine whether the estimated time is shorter than the alarm threshold value or not (step 106). When it is determined that the estimated time does not reach the alarm threshold value, the system continues to operate normally. Otherwise, the alarm information is sent to the administrator automatically according to the presetting (step 108), for example, by an email or a clear prompt on an administration interface. Thus, the administrator takes corresponding measures according to the current situation after the alarm information is received, for example, informing the user that the space will soon be used out, or manually expanding the space for the user.

Preferably, an automatic capacity expansion mechanism of the storage space can be preset. If the administrator does not respond in time, and the remaining storage space is further reduced, it is determined whether the system sets the automatic capacity expansion mechanism or not (step 110). If the space automatic capacity expansion mechanism is included, then it is determined whether the remaining available space reaches a capacity expansion threshold value of the space or not (step 112). If reaching the capacity expansion threshold value, the capacity will be expanded according to a step length (step 114), so as to ensure the continuous access to the storage space of the user. Otherwise, the system continues to operate, and the determination is performed continuously until the available space reaches the set capacity expansion threshold value. Here, the step length of the space expansion can be set by the administrator, or is set by the system according to the current operation state automatically. The expanded capacity for each expansion is normally in a unit of megabit (M), so as to provide enough space to the user and to prevent the waste of space at the same time.

After the capacity expansion, relevant events can be recorded in a log (step 116). In case that it is determined that no automatic capacity mechanism is used, step 116 is performed directly to record the events in the log. Then, the system continues to operate, and the operation state of the system is monitored in real time (step 118).

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An alarm method for insufficient storage space of a network storage system, comprising:
presetting a time alarm threshold value according to a current operation state of the system before allocating storage spaces to users;
estimating a time value that written data fully occupy a current remaining space according to a data writing speed to the storage space, a current idle memory of the system, total dirty data in a cache of the system, and a current remaining space in the storage space;
comparing the estimated time value and the time alarm threshold value; and
sending alarm information when the estimated time value is smaller than the time alarm threshold value.

2. The alarm method for insufficient storage space of a network storage system as claimed in claim 1, further comprising a step of presetting automatic capacity expansion of the storage space.

3. The alarm method for insufficient storage space of a network storage system as claimed in claim 2, wherein when the current remaining space reaches a preset capacity expansion threshold value, the current remaining space is expanded according to a step length.

4. The alarm method for insufficient storage space of a network storage system as claimed in claim 3, wherein a capacity of the current remaining space expanded each time is in a unit of megabit (M).
